(19) United States
(12) Patent Application Publication
(10) Pub. No.: US 2003/0235368 A1
(43) Pub. Date: Dec. 25, 2003

(54) Pi -Shifted filters based on electro-optically induced waveguide gratings

(75) Inventors: Mykola Kulishov, Pierrefonds (CA); Xavier Daxhelet, Montreal (CA)

Correspondence Address: DARBY & DARBY P.C., Post Office Box 5257, New York, NY, 10150-5257, US

(73) Assignees: ADTEK PHOTOMASK INC.; and; Mykola KULISHOV

(21) Appl. No.: 10/454,760

(22) Filed: Jun. 3, 2003

Related U.S. Application Data
(60) Provisional application No. 60/384,415, filed on Jun. 3, 2002.

(51) Int. Cl. G02B 6/34

(52) U.S. Cl. 385/40; 385/37

(57) ABSTRACT

Disclosed is a π-shifted optical grating device based on electro-optically induced waveguide gratings. The waveguide has a core and a cladding where the core or the cladding is made of an electro-optic material. A plurality of electrodes are placed on one side of the waveguide and at least one electrode is placed on the other side of the waveguide. A voltage pattern is selectively applied to the electrode so that the pattern induces at least one π-shifted grating in the waveguide when the pattern is applied.

### FIELD OF THE INVENTION

The present invention relates to optical filters and more particularly concerns reconfigurable and multi-functional pi-shifted filters based on electro-optically induced waveguide gratings.

### BACKGROUND OF THE INVENTION

For many applications, the transmission characteristics of a fiber grating are really the wrong way around: it is a band-stop rather than a band-pass. For example, tuning a radio enables the selection of a channel, not the rejection of it from a broad frequency spectrum. However, traditional fiber gratings, short period (Bragg) as well as long period ones, work quite in reverse, and therefore cannot be easily used for channel selection.

Several band-pass filter designs using fiber gratings have been constructed. The combination of FBGs and an optical circulator can turn a reflection-type filter into a transmission-type filter, but optical circulators can be costly and cause serious additional losses.

Attempts have been made to design a band-pass filter from a single grating. One solution suggested in the prior art is to introduce a π-shift in the middle of the grating. FIG. 1 (PRIOR ART) demonstrates an example of π-shift in harmonic distribution. It is believed that this idea was first proposed in 1976.

A π-shift in a grating may be introduced in several ways. Post-processing of the uniform grating in a certain region creates a permanent phase-shifted region (π-shift). This occurs because an extra exposition to ultraviolet (UV) light changes the refractive index in that region, creating an additional phase step. However, post-processing may be difficult to execute in practice, especially in short gratings. A better procedure is to use phase-shifted phase masks to introduce the desired π-shift in a grating. All these techniques are however time consuming and once phase shift is introduced, little can be done to change its position, magnitude or eliminate it at all.

There is therefore a need for pi-shifted optical gratings that are easier to make and more versatile in their application than prior art devices.

### SUMMARY OF THE INVENTION

It is an object of the invention to provide a device for selectively inducing a π-shifted filter. In accordance with the invention, this object is achieved with a waveguide having at least one selectively actuated π-shifted grating therein, comprising:

a core and a cladding, wherein said core or cladding is made of an electro-optic material;

a plurality of electrodes on one side of said waveguide;

at least one electrode on another side of said waveguide opposite said one side;

means for selectively applying a voltage pattern to said electrodes so that said pattern induces at least one π-shifted grating when said pattern is applied.

In accordance with an aspect of the present invention, there is provided a pi-shifted optical grating device based on electro-optically (EO) induced waveguide gratings. Preferably, the electro-optically induced gratings are of the type shown in FIG. 2, but the scope of the invention is not limited thereto. To induce a π-shift in such a grating, the applied voltage polarity for a portion of the electrode fingers is simply reversed. In this manner, the π-shift(s) can be conveniently induced or removed at will in any portion of the grating.

Referring to FIGS. 3a, 3b, 3c and 3d there are shown examples of structures illustrating the principles of the present invention. FIG. 3a shows the central portion of an EO grating without any π-shift, while FIG. 3b shows the same structure in the center of which the electrodes polarities have been reversed to introduce the π-shift. FIGS. 3b and 3c show a similar before and after scheme, with the difference that in the former case constant and variable components of electric field are induced inside the waveguide with a variable with periodicity l, whereas in the latter case only a variable component of the electric field distribution with periodicity 2l is created.

Further advantages and features of the present invention will be better understood upon reading of preferred embodiments with reference to the appended drawings.

### BRIEF DESCRIPTION OF THE DRAWINGS

FIG. 1 is a schematic representation of a uniform grating and one with a pi-shift;

FIGS. 2a) and 2b) are a representation of two preferred embodiments of the present invention, a) where both top and bottom electrodes are discrete and b) where the bottom electrode is continuous;

FIGS. 3a)-3d) are representations of the introduction of a π-shift into EO superimposed gratings, (a,b) where the central part of the structures is without the π-shift and (c,d) where the central part of the structures is with the π-shift;

FIGS. 4a) and 4b) show the transmission spectra of the EO-induced LPG without π-shift (solid) and with π-shift (dashed) for a) equal κL-product value 0.5π and b) for κL-product value 0.5π for the uniform grating and κL-product value 0.706π for the π-shifted grating;

FIG. 5 shows the transmission spectra for the π-shifted grating with κL-product value 0.706π (solid) andκL-product value 2.118π (dashed);

FIGS. 6a) and 6b) show two different schemes of the electric potential application to the IDE for effective coupling between the modes with different symmetry;

FIG. 7 shows the transmission spectra for different positions of π-shift within the grating: Δ=0 (κL=0.706π) solid line; the dotted line is for Δ/L=0.1 (κL=0.741π); the dashed line is for Δ/L=0.2 (κL=0.864π); and the bold dotted line is for Δ/L=0.285 (κL=0.882π);

FIG. 8 shows the transmission spectra of the grating with one (κL=0.706π, solid line), two (κL=0.76π, dotted line), three (κL=0.77π, dashed line), four (κL=0.78π, dot-dashed line) and five (κL=0.79π, bold line) symmetrically positioned π-shifts plotted versus the normalized wavelengths;

FIGS. 9a), 9b) and 9c) show the layout of EO reconfigurable grating-filter structure: (a) single grating; (b) grating with single π-shift; and (c) multiple π-shifted gratings;

FIG. 10 shows the transmission spectra of the gratings with five symmetrical π-shifts: κL=1.385π; L₁=L₆=2.125Lᵢ (solid line) and κL=0.79π; L₁=L₆=0.5Lᵢ (dashed line);

FIG. 11 shows the creation of a Mach-Zender interferometric filter by grounding M IDE finger pairs in the middle of the structure;

FIGS. 12a) to 12f) show the transmission spectra of the MZ filter with M grounded IDE finger pairs (solid line) for the grating with the period 2l as against the spectrum with the uniform grating (dashed line) with the same coupling coefficient and the number of activated IDE fingers;

FIGS. 13a)-13d) show the electrode structure and the potential application scheme to induce two superimposed gratings (a) with l and 2l periods; (b) the same gratings with π-shifts; (c) π-shifted configurations for ΔV=0; and (d) ΔV=−2V₀.

FIGS. 14a) and 14b) show the transmission spectra for the two superimposed gratings of FIG. 13 without (dashed line) and with π-shift (solid line) and (b) demonstration how contribution for the π-shift superimposed gratings can be controlled through ΔV voltage.

FIG. 15 shows the reflection spectra of EO induced induced Bragg gratings with π-shift (solid line) and without π-shift (dashed line) for (a) κL=2 and (b) κL=6.

FIG. 16 shows the reflection spectra for different positions of π-shift within the EO induced Bragg grating for κL=2 for (a) Δ/L=0; (b) Δ/L=0.08; and (c) Δ/L=0.22.

FIG. 17 shows the reflection spectra of the EO induced Bragg gratings with one (solid); two (dotted); three (dashed); four (dot-dashed); and five (bold-dotted) symmetrical π-shift for κL=4.

FIG. 18 shows the reflection spectra of the Fabry-Perot type EO induced grating filter for (a) the sub-gratings of a fixed length L/2=(N−M)/2; and (b) for the sub-gratings with variable length L/2=(N−M)/2 for M grounded IDE fingers and the center: M=500 (solid); M=600 (dotted); M=700 (dash); and M=800 (dot dash).

FIG. 19 shows the reflection spectra for a Fabry-Perot tunable filter composed from EO induced Bragg gratings with M disabled (grounded) IDE fingers where each sub-grating consists of N/2=1000 enabled IDE fingers with (a) M=500 (solid), M=1500 (dash); and (b) M=2500 solid and M=3500 (dash).

FIGS. 20 a) and b) show the electrode structure and potential application scheme to provide a π-shift according to another preferred embodiment of the invention, where (a) the electrodes are interdigitalized and symmetrical and (b) the bottom electrode is solid.

### DESCRIPTION OF PREFERRED EMBODIMENTS OF THE INVENTION

1. Introduction

An optical fiber (waveguide) grating is generally used as a filter for selecting an optical signal at a specific wavelength(s) from multiple wavelengths propagating along a core. The optical grating can eliminate or reflect light at a specific wavelength by inducing a periodic change in the refractive index of a waveguide. The optical grating is categorized into short (Bragg) period gratings (FBG) and long period gratings (LPG).

A FBG reflect light at a specific wavelength in the filtering process, whereas a LPG or transmission grating removes light without reflection by converting the optical signal component which must be removed from the core mode into the cladding mode. We will start our description with LPGs which includes a plurality of refractive index perturbations spaced along the waveguide by a predetermined distance that ranges from tens of microns to several hundreds of microns.

The present invention concerns the inducement of gratings into an electro-optic sensitive medium in an optical waveguide structure, but it should be recognized that the present invention can also find application in optical fibers.

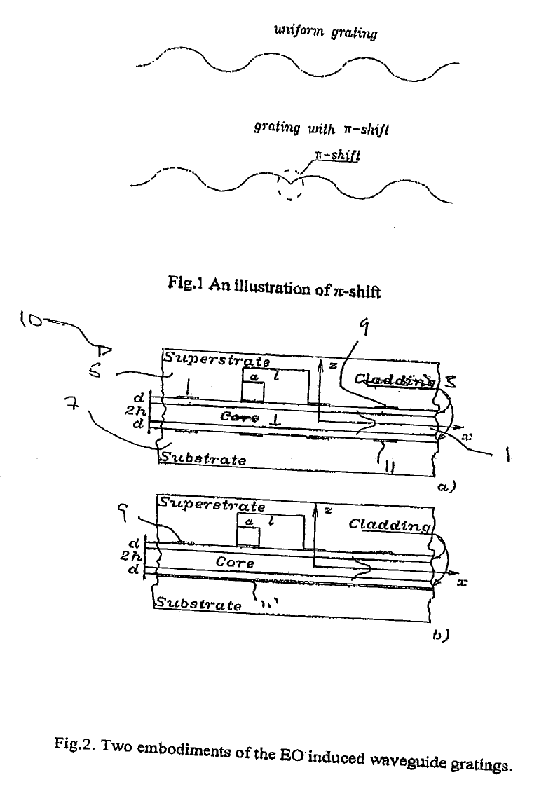

In essence, the present invention is directed to a method and apparatus for inducing the π-shift into a waveguide, the waveguide comprising a core and a cladding (FIG. 2), preferably mounted on a substrate (on a bottom portion thereof) and a superstrate (top portion thereof). It will also be apparent to a person skilled in the art that the words “top” and “bottom” are for ease of comprehension only.

A plurality of electrodes 9 is placed on one side of the top cladding. In the case illustrated in FIG. 2, the electrodes 9 are placed on the top cladding on the side of the superstrate and will be referred to a “top electrodes” for ease of description.

At least one electrode 11 is placed on the other side of the core (i.e. in FIG. 2, on the side of the substrate). However, the present invention also contemplates using a plurality of electrodes 11 on the other side, where the electrodes 9, 11 are symmetrical about a longitudinal axis. The at least one electrode (FIG. 2b) and the plurality of electrodes (FIG. 2a) will be hereinafter referred to as “bottom electrodes”.

In a planar waveguide, the grating can be induced in top or bottom cladding, i.e. the top cladding can be electro-optic, and the core and the bottom cladding are not, or the bottom cladding can be made from an electro-optic material and the core and the top cladding are from non-electro-optic one(s), or finally the core can be electro-optic, and the top and bottom claddings are not. However, unlike a planar waveguide, for a fiber, or a circular waveguide, it is impossible to make distinction between the top and bottom claddings and so the grating can only be included in the core or the cladding.

In a preferred embodiment, the top and bottom electrodes are interdigitated electrodes (IDE).

2. Reconfigurable Band-Pass Filters on the Basis of EO Induced Long Period Gratings

2.1. Single π-Shift structure

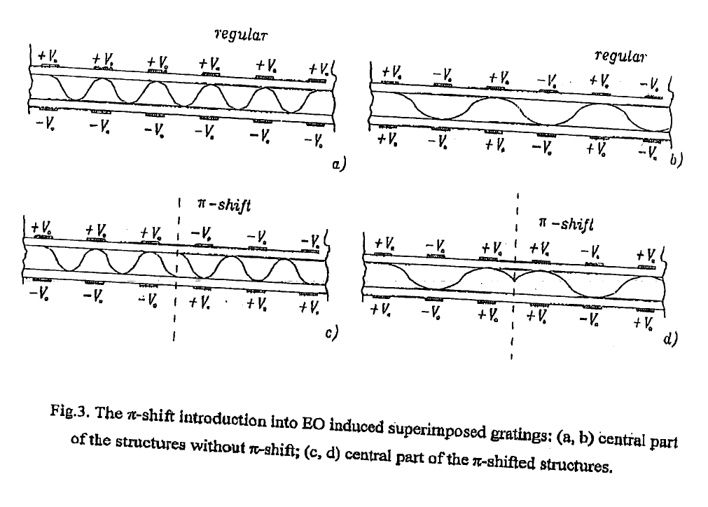

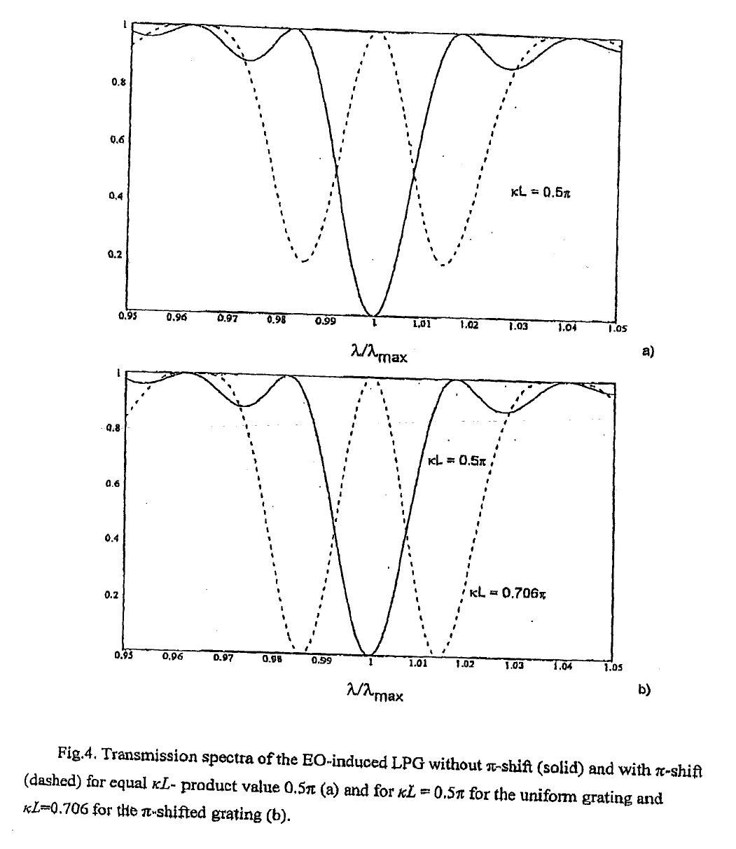

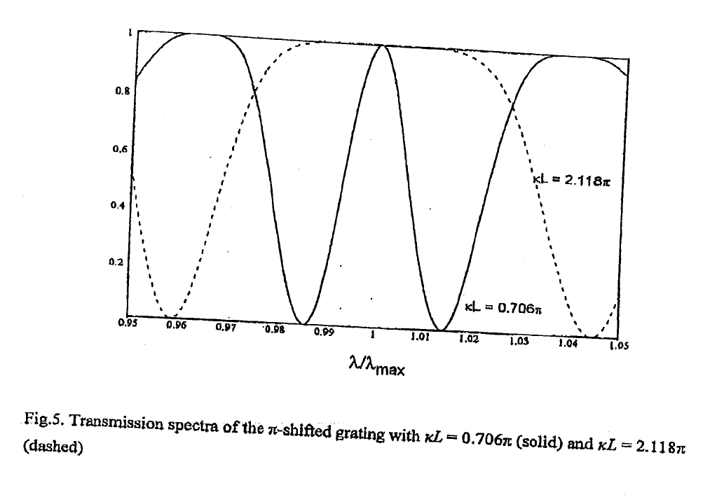

The solid curves in FIG. 4 give an example of transmission spectra (solid) of the electro-optically (EO) induced waveguide grating without π-shift (FIG. 3b) and with π-shift, when fingers of interdigitated electrode (IDE) along the second half of the structure length are inversely biased in respect to the first half (see FIG. 3d). Because the grating is induced electro-optically, it is always possible to switch between two types of spectra presented in FIG. 4. The grating also can be switched OFF if the electric potential difference between the electrodes is equal to zero and behaves as a low-loss waveguide. It is well known that 100% out-coupling from the core mode to the cladding mode takes place for κL=0.5π, where L is the grating full length, and κ is the coupling coefficient. For the π-shifted grating this value is not enough to achieve full rejection in the two loss dips (see FIG. 4a). To get 100% losses in these dips, as in FIG. 4b, κL- value should be increased to 0.706π, which can be done in our design just by increasing difference of potential, V₀, 1.4 times or by increasing the grating length L through activating additional number of IDE fingers. Therefore special attenuation in the dips around the band-pass gap can be controlled electronically.

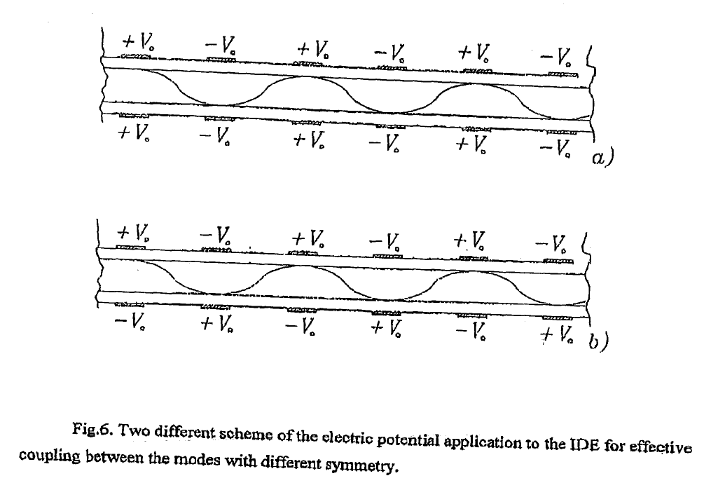

The spectrum with band-pass gap also can be electronically switched to about three times wider bandwidth, as it can be seen from FIG. 5, by increasing the κ L product three times, κ(V₀)L=3×0.706π. Of course, it has to be appropriate dynamic range of the device for adjusting the κ L - product. To provide the dynamic range the structure design should be optimized for proper external electric field distribution to maximize the overlap integral for core-cladding mode interaction. For example, the electric potential application pattern in FIG. 6a is more suitable for coupling the fundamental core mode into the odd (asymmetric) cladding modes, whereas the configuration of the electric field from IDE in FIG. 6b is more effective for interaction between the fundamental mode and even (symmetric) cladding modes.

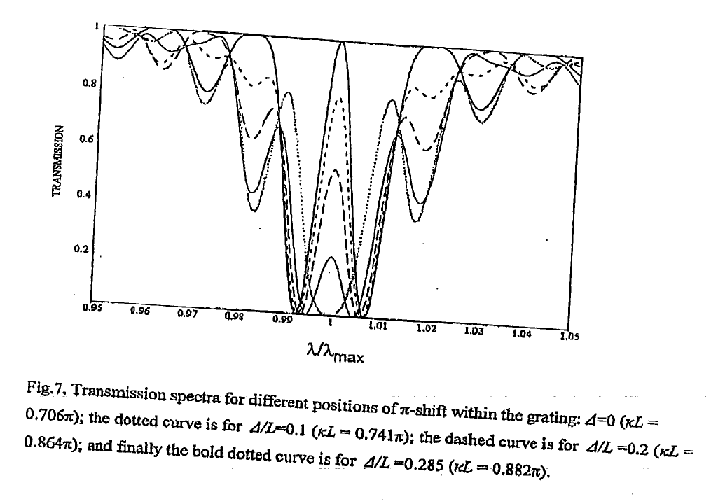

All transmission spectra in FIGS. 4 and 5 are for the π-shift in the middle of the EO induced grating. However with proper designed electronic interface, the position of the π-shift can be controlled electronically, moving it to right or left side and dividing the grating into two sections, the first section having a length of L-Δ and the second section having a length L+Δ, where Δ is the distance of the π-shift from the center. As we can see in FIG. 7, by moving the π-shift toward the one end of the grating, the two dips will move closer to each other and finally merge into one dip at Δ/L^{˜}0.285. In FIG. 7 the solid curve is for Δ=0 (κL=0.706π); the dotted curve is for Δ/L=0.1 (κL=0.741π); the dashed curve is for Δ/L=0.2 (κL=0.864π); and finally the bold dotted curve is for Δ/L=0.285 (κL=0.882π). This kind of tunable filtering behavior can be used for variable optical attenuation.

2.2. Multiple π-Shifts

As we have shown, π-shifted EO induced grating produces transmission gap in the stop-band which can be switched ON and OFF. In many applications, it is desirable to control the bandwidth of the transmission gap, and to obtain a flatter response in the band-pass region. This can be achieved with a cascade of π-shifts sandwiched between sub-gratings. This concept was used for filter design with the help of ultraviolet imprinted sort-period (Bragg) cascaded gratings. Depending on the length of the sub-gratings, many peaks may appear or they may coalesce into one.

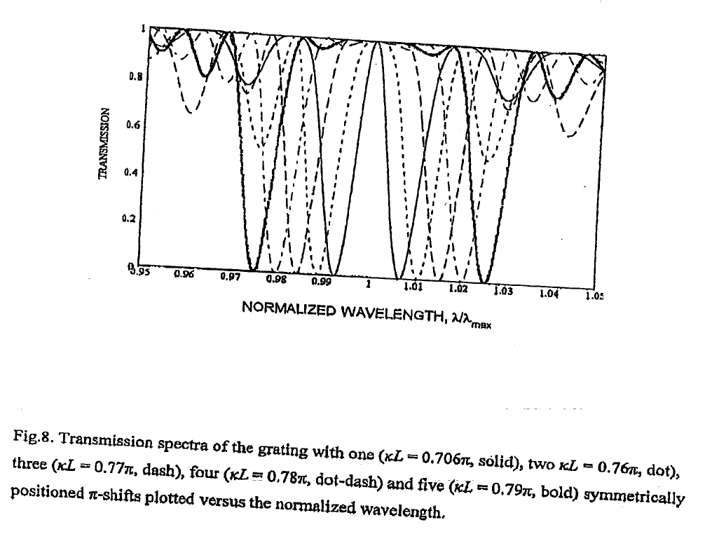

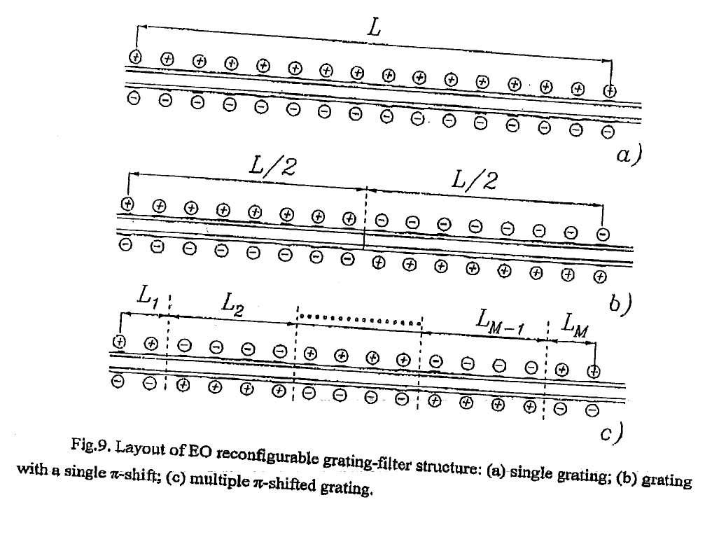

In the proposed design of EO induced waveguide grating multiple π-shifts can be introduced or removed as easy as a single π-shift that makes this grating truly reconfigurable filter. FIG. 8 demonstrates how the width of the band-pass gap can be changed by introducing several, generally M-1 (M3), symmetrical π-shifts form one to five, where we can see transmission spectra of a long period grating with one (κL=0.706π, solid), two κL=0.76π, dot), three (κL=0.77π, dash), four (κL=0.78π, dot-dash) and five (κL=0.79π, bold) symmetrically positioned π-shifts. It is assumed that the positions of the π-shifts (or positions of the bias voltage inversion) are symmetric with respect to the center (see FIG. 9(c)), i.e. sub-grating (or portions with the same voltage polarity) lengths are L₁=L_{M}=L_{O UT} and L₂=L₃=. . . =L_{M-1}=L_{I N}.; L_{I N}=2L_{O UT} and L=2L_{OUT}+(M−2)L_{I N}. The signs + and − in FIG. 9 denote positive and negative voltage at the two pairs of electrodes to provide the electric field without constant spatial component, i.e. zero “dc” coupling coefficients.

It is worthwhile noting that the bias voltage V₀ has to be adjusted when transmission is reconfigured between different band-pass windows in FIG. 8. The bias voltage should maintain proper values of the κL product that corresponds to the filter rejection level −35 dB. The product value is changed from κL=0.5π for the grating without π-shift and correspondingly without the band-pass gap, to κL=0.79 for the grating with five π-shifts. When all the IDE fingers are activated, the bias voltage is the only parameter to adjust. For the above example it has to be increased 1.58 times.

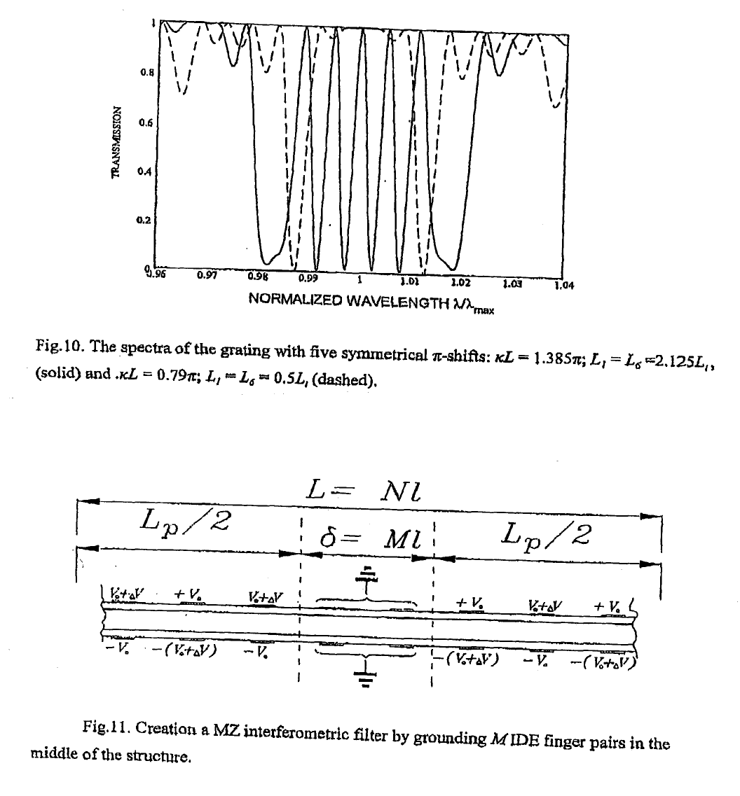

The proposed design provides a broad range of different spectra that can be easily reconfigurable between one another provided a good computer controlled electronic interface to apply a proper electric potential distribution to the IDE fingers. FIG. 10 gives another example of two spectra for the grating with five symmetric π-shifts, where for the solid curve κL=1.385π; L₁=L₆=2.125Lᵢ , and the dashed curve is the same as in FIG. 8 for five π-shift structure, i.e. .κL=0.79π; L₁=L₆=0.5Lᵢ.

2.3. Mach-Zehnder Band-Pass Filters

As we already mentioned, the coupling in our EO induced grating does not occur without the presence of the voltage at IDE fingers. That creates another opportunity to split our superimposed gratings into two sections by disabling (grounding) a number of IDE fingers in the middle of the structure. Two sequential long period gratings with a space between them act as a Mach-Zehnder (MZ) interferometer for the range of wavelengths for which coupling is enabled. The first grating (the section in our case) couples part of the core mode intensity into the cladding mode, and the second grating (section) recombines them. Due to the phase difference accumulated by propagation through the core and the cladding respectively, they will interfere, constructively or destructively, depending on the wavelength and the space between the gratings (sections) leading to a periodic transmission spectrum. By varying the space length, coupling coefficients, the structure of the transmission spectrum can be changed.

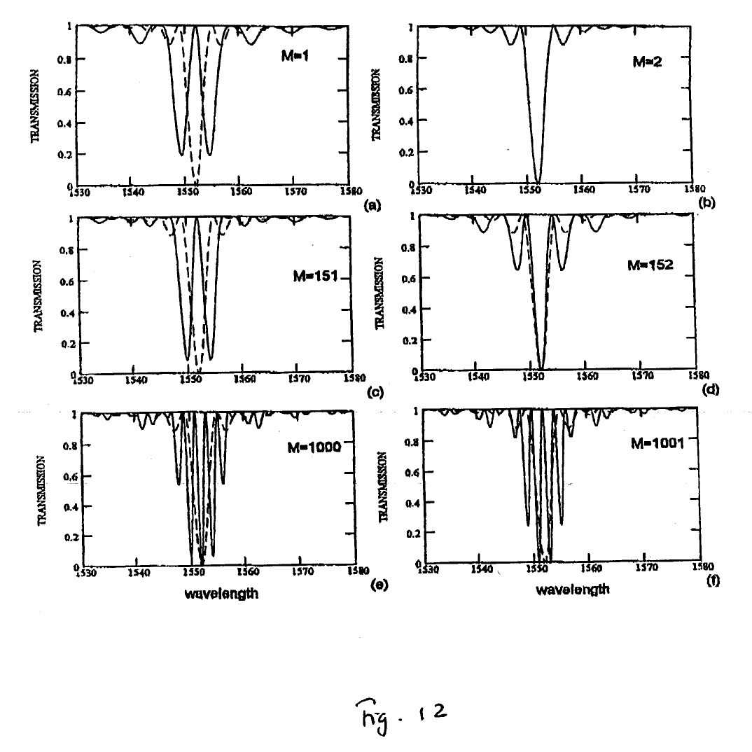

In FIG. 11 the central part of the structure is shown where several pairs of IDE fingers (from one to M) are grounded creating separation δ=IM in the middle of the structure. Control of the balance between L_{P} and δ=L−2L_{P} allows easy alteration of the stop-band.

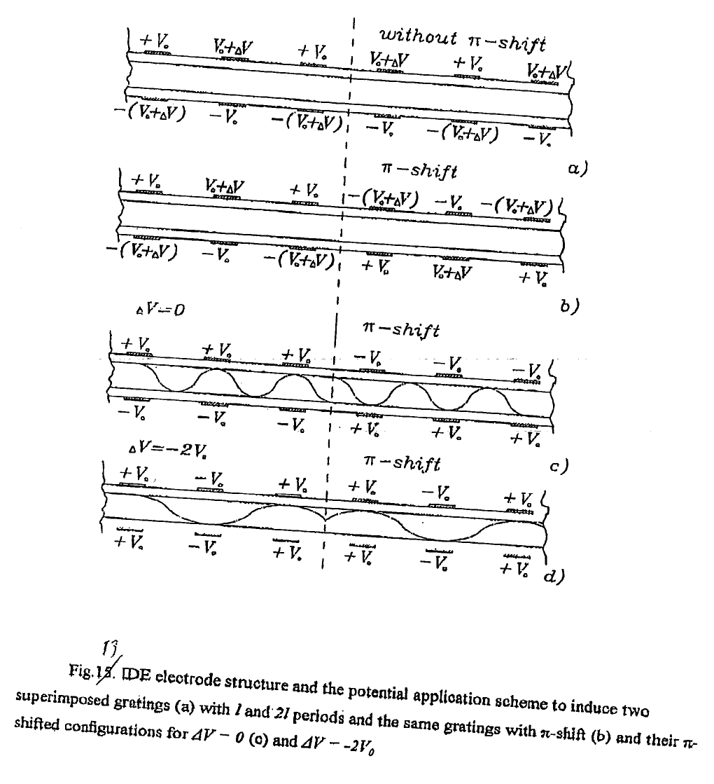

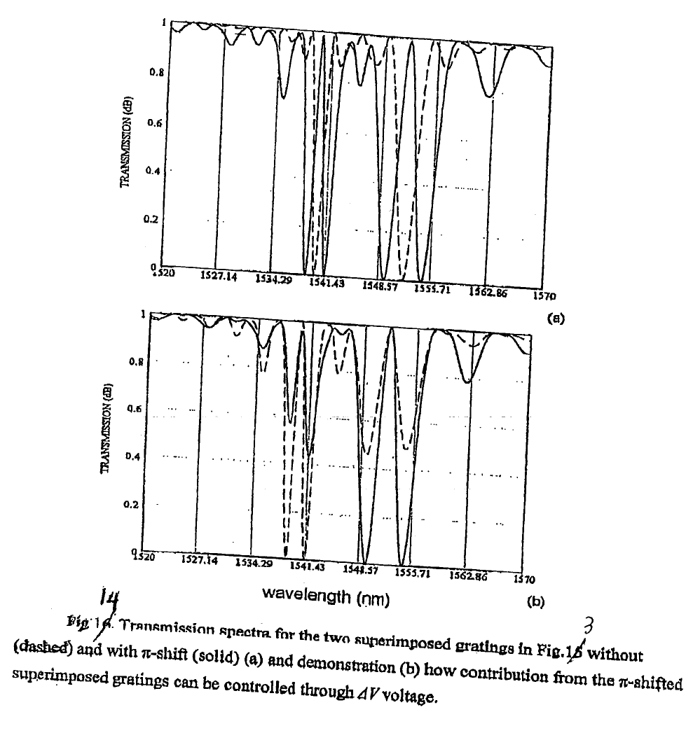

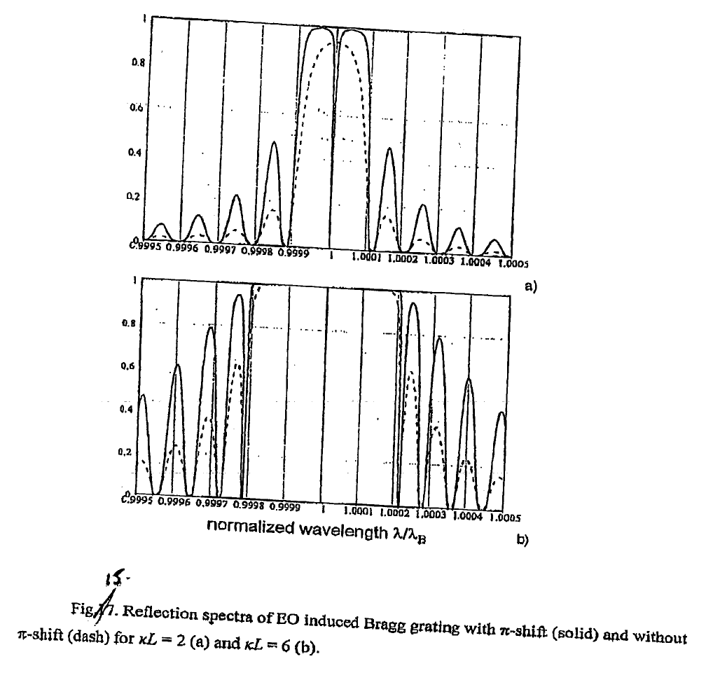

In FIG. 12(a-f) the transmission spectra are shown for the grating with periodicity 2l (FIG. 3b,d) with correspondingly M=1, 2, 151, 152, 1000, and 1001 grounded finger pairs. In the simulation we maintained the constant number of electrodes under the potential in the both section. In this situation we should have an appropriate number of disabled (grounded) electrodes on the right and left ends of the structure, which are activated as the electrodes in the middle part are disabled. All spectra are plotted as against the spectrum of the uniform grating (without IDE finger grounding, dashed curve). As we can see, grounding one or any small odd number of electrodes (FIG. 12a) gives us exactly the same effect as reversing the voltage polarity (π-shift) described in the first section, whereas grounding of small amount of even number of electrodes practically does not change the spectrum at all (FIG. 12b). Increasing the amount of grounded electrodes in the middle can be used to at least partially suppress the side lobes as it can be seen comparing spectra in FIG. 12a and FIG. 12c. To produce the spectra with multiple gaps the distance between the sections has to be comparable with the section length (FIGS. 12e and 12d).

In our design, side-lobe suppression can be also easily done by modulating the voltage V₀ along the grating length using Gaussian, raised-cosine or any other apodization profiles.

In the case of potential application pattern in FIG. 3a, V₀ modulation results in changing the constant component of the electric field along the grating length. This change of constant component causes the change in EO-induced value of average refractive index that has the same effect as a grating chirp introduction. Therefore the grating also can be controlled in terms of its phase group delay or dispersion.

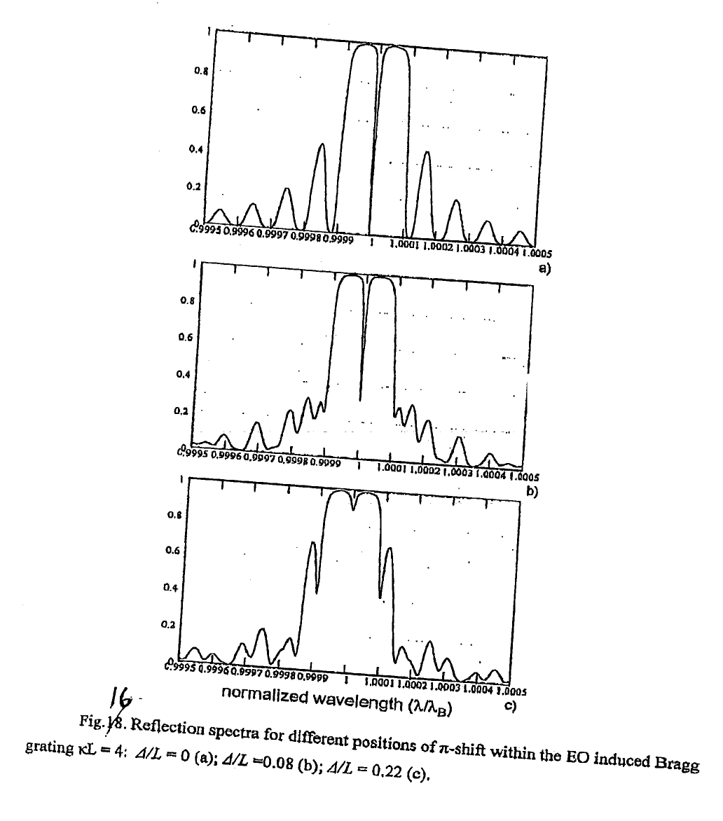

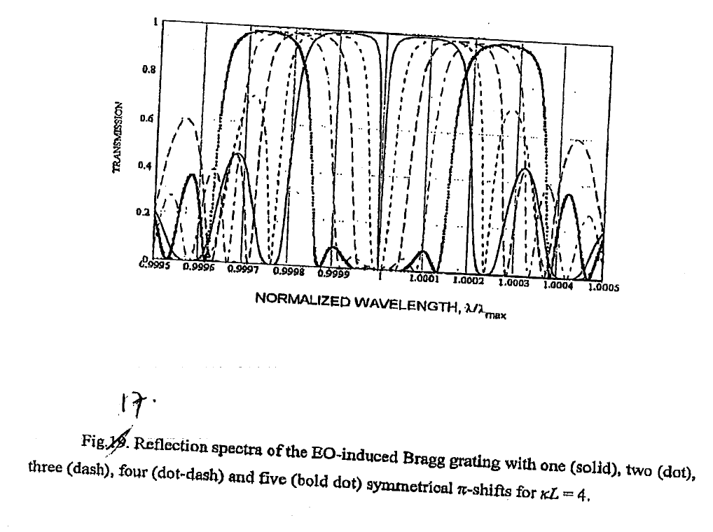

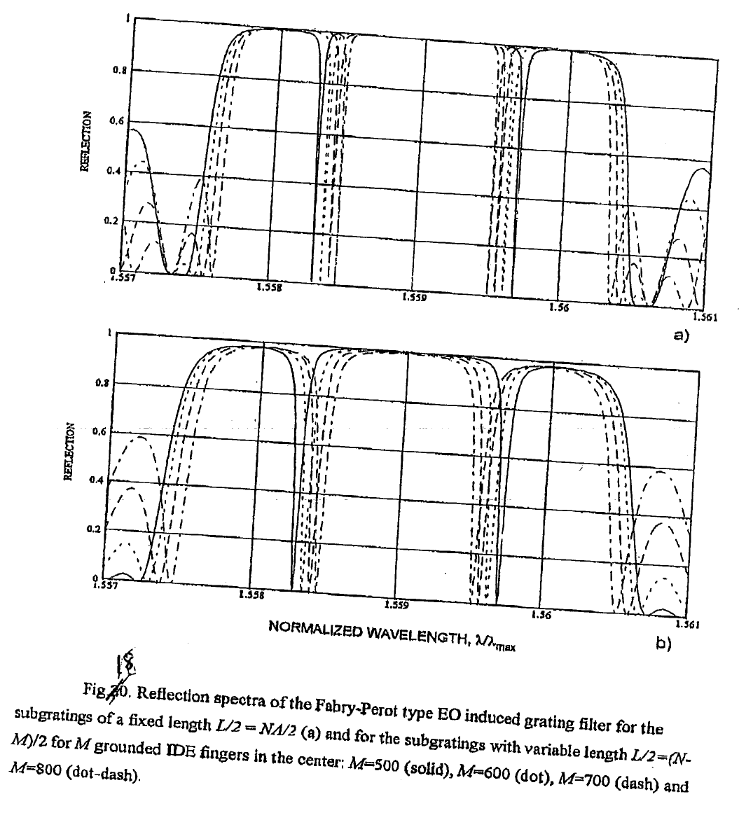

We analyzed the MZ filtering characteristics separately for the two different potential application schemes (FIGS. 3a and 3b). However it is obvious that these two schemes can be used together to control electronically their individual contributions. The combined electric potential scheme is presented in FIG. 13a in its uniform distribution (without π-shift) and with π-shift in FIG. 13b. For clarity the two initial potential application schemes are shown as particular cases in FIG. 13c and 13d. These two initial schemes are realized when ΔV=0 and ΔV=−2V₀. For −2V₀<ΔV<0 the both periodic distributions are present and their contributions can be controlled electronically by ΔV voltage. This design can be useful for LPG where the beating length between the core fundamental mode and the i-th cladding mode is close to double value of the beating length between the core fundamental mode and the j-th cladding modes. FIG. 14a demonstrates the double-dip spectra (dash) 13 of the superimposed gratings and appearance of band-pass gaps in the middle of the dips (solid) when the π-shift is introduced by the electric field reversing and it also demonstrates control over transmission losses of the π-shifted gratings by ΔV-voltage in FIG. 14b.

3. Reconfigurable Filters on the Basis of EO Induced Bragg Gratings

The same principle of EO induced grating can be used for contra propagating interaction of guided modes that reflects light at a specific wavelength based on Bragg diffraction. This type of gratings requires submicron periodicity Λ estimated by simple formula: Λ=λ_{B}/(2n), where λ_{B} is the Bragg resonance wavelength, and n is the average refractive index of the waveguide core material. For infrared telecommunication wavelengths and for silica type materials this period is about half a micron. It means that our IDE structure should have a period l equal Λ for the potential application scheme in FIG. 3a or l=Λ/2, if we are considering application scheme, shown in FIG. 3b. It is not a simple task to do, nevertheless a number of sensor and microbiological applications have already demonstrated that submicron IDE structures are feasible, and the rapid advance in nanoscale technology promises to make this type microfabrication a routine task in the nearest future. However the nature of a non-uniform electrostatic field is that it decays rapidly with distance away from the IDE. The spatially variable field components are essentially washed out at a distance from the IDE equal to the IDE period. It imposes restriction on the wavelength thickness that should not be larger than 1 μm. This size of waveguide is not uncommon for semiconductor-based waveguide, where the high difference Λn between cladding and core indices forces to use very thin waveguide to maintain single-mode operation. Still such thin waveguides create problems in fiber coupling that prompts to use complex design techniques to avoid substantial coupling losses.

There is a solution allowing to use IDE with longer period, and as result with thicker waveguide. It is to use higher spatial harmonic of the periodical electrostatic field distribution instead of the fundamental one. However higher spatial harmonics decrease rapidly in their magnitude with the harmonic order m, especially for the application scheme in FIG. 3a.

The situation is even tougher for the potential application scheme in FIG. 3b, where IDE period should be a half of the Bragg grating period. However this situation can be different if we use EO material with quadratic (Kerr) effect instead of linear (Pockels) one. This potential configuration creates an electric field in the waveguide that can be described the following Fourier series:

$${E}_{z} ( x , z ) = \frac{{V}_{0}}{h} ( {A}_{1} ( z ) cos ( \frac{π x}{l} ) + {A}_{2} ( z ) cos ( \frac{3 π x}{l} ) + {A}_{3} ( z ) cos ( \frac{5 π x}{l} ) + … + )$$

For a linear EO material, the refractive index change is proportional to the normal component of the electric field, E_{Z} (x,z), therefore the fundamental spatial harmonic has the period of 2l. However for a quadratic EO material the refractive index change is proportional to E_{Z} (x,z) squared. As a result we will get the first two spatial harmonics with the wave numbers:

$$\frac{3 π}{l} - \frac{π}{l} = \frac{2 π}{l} ; \frac{3 π}{l} + \frac{π}{l} = \frac{4 π}{l} ;$$

i.e. the periods l and l/2 and with magnitudes proportional to A₁(z)A₂(z). Presently there are not too many quadratic EO materials with strong enough Kerr effect. One of the actively explored materials is lead modified lead zirconate titanate (PLZT), with EO coefficient about 10⁻¹⁷ m²/V² however it has high intrinsic refractive index (about 2.3-2.4) that requires Bragg grating periodicity 1.55 μm/(2×2.3)≈0.32-0.34 μm. The good candidate for this application might be isotropic polymer dispersed liquid crystals (PDLC) with intrinsic refractive index close to 1.6 and very high EO coefficient 2 10⁻¹⁷ m²/V² for 1.5 μm wavelength.

3.1. Single π-Shift

The solid curves in FIGS. 15a and 15b show us reflection spectra of the EO-induced Bragg gratings with a single π-shift in the middle for different values of κL -product (κL=2 for FIG. 15a and κL=6 for FIG. 15b), whereas the dashed curves represent spectra without π-shift. As we can see, the π-shift opens very narrow transmission gap with a Lorentzian line shape. This gap can be switched ON and OFF in our design or the spectrum itself can be reshaped by changing coupling coefficient κ(V₀), or through grating length variation by enabling or disabling the IDE fingers.

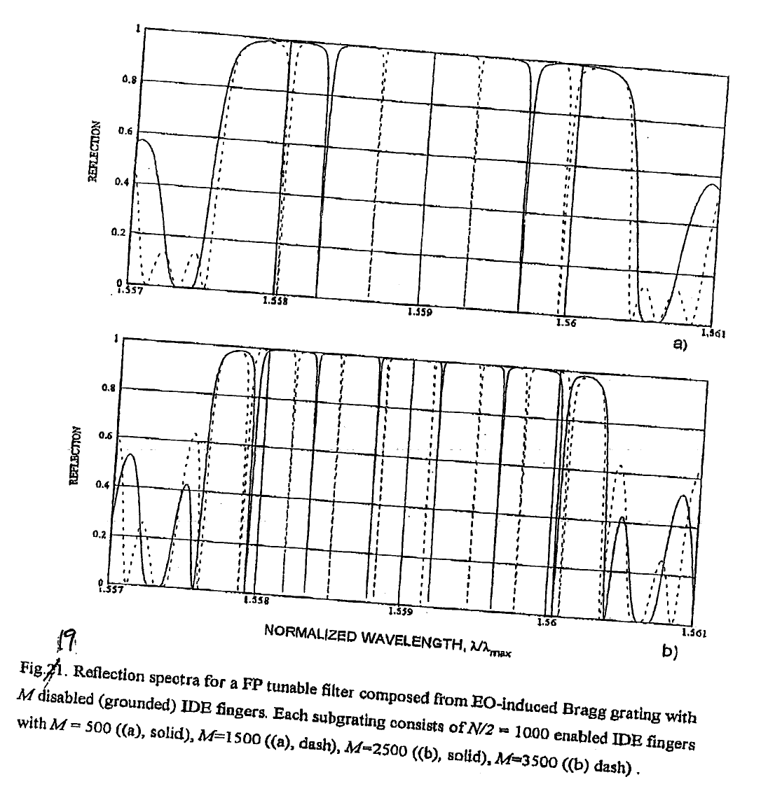

Moving the position of the π-shift from the center to the left or right side creates similar effect of gradual change in transmission within the gap from 100% for Δ=0 to 0% for Δ=0.25, as it can be seen in FIG. 16.

3.2. Multiple π-Shifts

In the same way as in the case of LPG, multiple π-shifts can be a powerful technique to control of the reflection spectrum. An example is presented in FIG. 17, where the spectra are presented for one, two, three, four and five symmetrical π-shifts similar to the structure for LPG in FIG. 9. The spectra were calculated for the structures where length of the two outer sub-gratings L_{OUT} are half of the length of inner sub-gratings L_{I N} for the structures with two or more π-shifts. We can see how strongly band-pass can be controlled by multiple inversion of the voltages on the IDE fingers. The ripple factor which is increased with a number of π-shifts, can be substantially reduced by controlling the L_{I N}/L_{OUT} ratio.

3.3. Fabry-Perot Filter

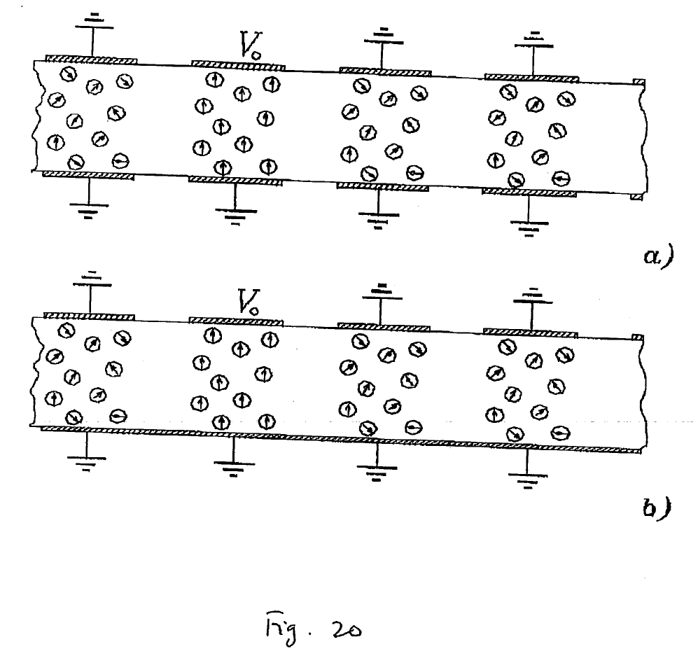

For the Bragg type EO induced grating grounding some fingers inside the structure creates a Fabry-Perot (FP) type cavity with its specific type of spectrum. By changing a number of the grounded IDE fingers, we can control the grating length L=L/2+L/2 and the distance between sub-gratings that in turn allows us easy alteration of the stop-band and the free space range (FSR). There are two options here: 1) the total number of enable IDE fingers in each sub-grating, N/2, is kept constant, i.e. disabling (enabling) a certain amount of IDE fingers in the sub-gratings from their inner cavity ends we simultaneously enable (disable) the same amount of IDE fingers in the sub-gratings from their outer ends; and 2) the total number of enabled IDE fingers in each sub-grating, (N-M)/2, increases (decreases) as we enable (disable) the IDE fingers of the sub-gratings from their inner (cavity) ends. FIG. 18 demonstrates the reflection spectra for the first option (FIG. 18a) and the second one (FIG. 18b) for the number of disabled (grounded) IDE fingers M=500 (solid), M=600 (dot), M=700 (dash) and M=800 (dot-dash) for N=2000 and κ=5000 m⁻¹.

In FIG. 19 we can see the reflection spectra for the first option when M=500 (FIG. 19a solid), M=1500 (FIG. 19a, dash), M=2500 (FIG. 19b, solid), M=3500 (FIG. 19b, dash), where the number of band-pass gaps is growing from two for M=500 to eight for M=3500. These two examples are calculated for identical sub-grating, however one should understand that the design can be used to induce dissimilar sub-grating it terms of their length or coupling coefficients.

4. Alternative Electro-Optic Materials.

So far we discussed electro-optic materials (isotropic or anisotropic) which are uniform in their intrinsic state. Periodical distribution of the refractive index can be induced through external spatially periodical stimulus (such as external periodical electric field). However there is a class of artificially synthesized materials, holographic polymer dispersed liquid crystals (H-PDLC), where the material already possesses spatial periodicity of its refractive index. The H-PDLC material comprises a transparent polymer material populated by periodical distribution of liquid crystal micro-droplets. Such droplet distribution forms holographic fringes, or, in the case of a waveguide, it can be short or long period gratings. Typically, the H-PDLC has two optical states corresponding to the electrical stimulus being ON or OFF, these being equivalent respectively to the grating being disabled or activated. In its normal or rest state the liquid crystal droplets tend to be randomly aligned. When the external electric field, is applied the droplets tend to re-orient such that that liquid crystal molecules become aligned with the direction of the applied electric field. This property is widely known in the art and is used to switch ON and OFF the hologram or waveguide grating(s).

We propose to use a structured electrode to selectively disable a fringe or a number of fringes within H-PDLC waveguide grating by applying an electric potential to a finger pair or a group of finger pairs keeping the rest of electrode grounded. This allows us to dynamically split the grating into arbitrary amount of subgratings (or Fabry-Perot resonators) with the same transmission spectrum manipulation freedom over the transmission spectrum as was described above, and shown in FIG. 20.

Of course, numerous modifications could be made to the embodiments described above without departing from the scope of the present invention.

1. A method of inducing a π-shifted electro-optic grating in a waveguide, said waveguide having a core and a cladding wherein said core or cladding is made of an electro-optic material, comprising the steps of:
(a) placing a plurality of electrodes on one side of said waveguide;
(b) placing at least one electrode on another side of said waveguide opposite said one side;
(c) applying a voltage pattern to said electrodes so that said pattern induces at least one π-shifted grating.

2. A method according to claim 1, wherein said step (b) consists in placing a plurality of electrodes on said another side of said waveguide, so that said plurality of electrodes on said one side and said plurality of electrodes on said another side are symmetrical about a longitudinal axis of said waveguide.

3. A method according to claim 2, wherein said electrodes on said one side and said electrodes on said another side are inter-digitated electrodes.

4. A method according to claim 1, wherein said step (c) consists in applying a voltage pattern to said electrodes so that said pattern induces two or more π-shifts in said waveguide grating.

5. A waveguide having at least one selectively actuated π-shifted grating therein, comprising:
a core and a cladding, wherein said core or cladding is made of an electro-optic material;
a plurality of electrodes on one side of said waveguide;
at least one electrode on another side of said waveguide opposite said one side;
means for selectively applying a voltage pattern to said electrodes so that said pattern induces at least one π-shifted grating when said pattern is applied.

6. A waveguide according to claim 5, wherein said waveguide further comprises a substrate and a superstrate.

7. A waveguide according to claim 5, wherein said at least one electrode on said another side of said waveguide is a plurality of electrodes, so that said plurality of electrodes on said one side and said plurality of electrodes on said another side are symmetrical about a longitudinal axis of said waveguide.

8. A waveguide according to claim 6, wherein said plurality of electrodes on said one side and said plurality of electrodes on said another side are inter-digitated electrodes.

9. A waveguide according to claim 6, wherein said pattern induces two or more π-shifts in said waveguide gratings.

10. A waveguide according to claim 5, wherein middle fingers of said top electrode and each of said at least one bottom electrode are placed at a same electric potential.

11. A waveguide having at least one selectively actuated π-shifted grating therein, comprising:
a core and a cladding, wherein said core is made of a holographic polymer dispersed liquid crystal;
a plurality of electrodes on one side of said waveguide;
a plurality of electrodes on another side of said waveguide opposite said one side;
means for selectively applying a voltage to at least one electrode and grounding the other electrodes so that at least one π-shifted grating is induced when said voltage is applied.

12. A method according to claim 1, wherein said step (b) consists in placing a plurality of electrodes on said other side of said waveguide, so that said plurality of electrodes on said one side and said plurality of electrodes on said another side are shifted with respect to each other about a longitudinal axis of said waveguide.

13. A waveguide according to claim 5, wherein said at least one electrode on said another side of said waveguide is a plurality of electrodes, so that said plurality of electrodes on said one side and said plurality of electrodes on said another side are shifted with respect to each other about a longitudinal axis of said waveguide.

14. A waveguide according to claim 10, wherein said same electric potential is zero.
